(19) United States
(12) Patent Application Publication
(10) Pub. No.: US 2013/0080305 A1
(43) Pub. Date: Mar. 28, 2013

(54) SYSTEM AND METHOD FOR INTERFACING TO MULTIPLE POINT OF SALE SYSTEMS

(71) Applicants: Mark A. Virag, Fort Lauderdale, FL (US); James J. Butler, Bartlett, IL (US); Thomas A. Barretta, Plymouth, MI (US)

(72) Inventors: Mark A. Virag, Fort Lauderdale, FL (US); James J. Butler, Bartlett, IL (US); Thomas A. Barretta, Plymouth, MI (US)

(73) Assignee: Open Dealer Exchange, LLC, Troy, MI (US)

(21) Appl. No.: 13/242,679

(22) Filed: Sep. 23, 2011

(51) Int. Cl. G06Q 40/00

(52) U.S. Cl. 705/35

(57) ABSTRACT

A system for interfacing a plurality of dealer computer systems located at independent automotive dealerships with a plurality of remotely located independent and financial and product provider computer systems operated by a plurality of independent provider systems. The system may incorporate a dealer system integration (DSI) interface system that interfaces the dealer computer systems to a provider network, where the provider network is in turn in communication with each of the product provider computer systems. The DSI interface may coordinate and assist with one or more of forms preparation, obtaining rates for specific products available from the various provider systems, and electronic booking of contracts, as well as other important operations or transactions between the dealer network and the dealer systems.

### FIELD

The present disclosure relates to systems and methods for interfacing with multiple point of sale systems typically used by automotive vehicle dealers to provide financial and warranty products to consumers, and especially to a system and method that enables a dealer's computer system to interface to multiple, disparate provider networks to obtain a wide range of financial, warranty, service and other types of products and services that may then be offered by an automotive dealer.

### BACKGROUND

The statements in this section merely provide background information related to the present disclosure and may not constitute prior art.

Various types of businesses, for example automotive dealerships, are involved in offering various products and services to consumers in connection with purchases that the consumer makes. In the automotive dealer industry, automotive dealers have a need to be able to offer various warranty products, financial products, and other service products to purchasers of vehicles at the time the vehicle is purchased, or even after the vehicle purchase is made. In this example the automotive dealer has a dealer computer system and may be viewed as the “point of sale” (POS) entity. Typically, to accomplish the offering of products and services from independent vendors, each automotive dealer is required to connect to some form of provider system or alternatively directly to specific independent providers. This connection is typically made over a wide area network, for example over the Internet. One provider system available for use today is the “Provider Exchange Network” (PEN) which links POS entities with a number of different independent provider services and is able to obtain financial and service contract rates, prepare forms, and electronically originate a contract with a financial and insurance (F&I) provider, in real time for the POS entity. Thus, whichever provider network is used, the provider network helps to link a number of POS entities with a number of independent provider services.

It will also be understood that every provider system has its own data structure. By this it is meant that the data structures used by the independent provider systems are idiosyncratic, meaning that they often differ significantly from one another. The provider network, however, is required to be able to read and reformat information or documents, when necessary, so that the documents and contracts provided to the POS entity requesting same are in formats, or are populated in specific ways, or are in accordance with protocols that are readily useable by the specific POS entity making the request. This has required the provider network to have a plurality of different interfaces that are adapted to accommodate the required interfacing tasks to communicate and exchange documents with a wide number of different POS entities and different independent provider systems. It has also required each of the POS entities to have its own, custom interface that is able to communicate with the provider network. So for example, a provider network (i.e., the application layer associated that effectively makes up the “provider network”) that must accommodate 10 different POS entities and 12 different independent provider systems may require up to 120 (10×12) different custom interface systems to achieve the necessary interfacing. As can be appreciated, this arrangement quickly becomes unwieldy as the number of POS entities and/or the number of provider systems grows. If all entities share a single network, the number of custom interfaces is reduced to 22, in this example, but the network still has the burden of translating data structures and application logic for all 120 combinations. An important objective of the present invention is to standardize data structures at the POS end, so that, in this example, only the 12 provider-side translations would be required.

### SUMMARY

In one aspect the present disclosure relates to an apparatus for exchanging financial and product information between a plurality of automotive dealer computer systems operated by a plurality of independent automotive dealers, and a plurality of remotely located, independent provider computer systems operated by independent product providers. The apparatus may comprise a provider network including a computer and a first data dictionary, the provider network being in communication with the dealer computer systems over a wide area network (WAN) and able to query each of the provider computer systems for at least one of financial and product information. A second data dictionary may be included in each one of the dealer computer systems. The second data dictionary system may include the data elements used by each one of the dealer computer systems registered with the provider network and mapped to a plurality of variables used by its respective said dealer computer system. A dealer system integration (DSI) apparatus may be included for interfacing each said dealer computer system, over the WAN, to the provider network. The DSI apparatus may be configured to register each said dealer computer system with the provider network; to receive a first request for rates for a financial product from a first selected one of the product providers, the first request being made by a first one of the dealer computer systems, and to coordinate a receipt and transfer of said rates for said financial product to said first one of the dealer computer systems. The DSI apparatus may also be used to receive a second request for a completed, specific form from a selected second one of the product providers along with required data for the form. The second request may be made by a second selected one of the dealer computer systems, and to coordinate a receipt and transfer of the completed, specific form to the second dealer computer system. And at least one of the dealer computer systems and the provider network may use the data dictionaries, when needed, to assist in completing a form required by a requested one of the dealer computer systems.

In another aspect the present disclosure relates to an apparatus for exchanging financial and product information between a plurality of automotive dealer computer systems and a plurality of remotely located, independent provider computer systems. The apparatus may comprise a first data dictionary, included in each one of the dealer computer systems, that includes a plurality of data elements mapped to a plurality of variables used by its respective said dealer computer system. A provider network may be included that comprises a computer and a second data dictionary system, the second data dictionary system including the data elements used by each one of the dealer computer systems registered with the provider network. The provider network may be in communication with the dealer computer systems over a wide area network (WAN) and able to query each of the provider computer systems for at least one of financial and product information. A dealer system integration (DSI) apparatus may be used for interfacing a dealer system computer, over the WAN, to the provider network. The provider network may be in communication with the dealer computer systems over a wide area network (WAN) and able to query each of the provider computer systems for at least one of financial and product information. The DSI apparatus may also be configured to use an extensible markup language (XML) template having at least one XML tag. The XML tag may represent a field where the dealer system computer of the one dealer system is to fill an appropriate data element from its respective said data element library. The DSI apparatus may also transmit the XML template back to the one dealer system computer that made the request, and then may receive the XML template back from the one dealer system after the one dealer system has filled in the appropriate data elements corresponding to the at least one XML tag, to thus form a completed XML template. The DSI apparatus may then transmit the completed XML template to the provider network for subsequent action by the provider network.

In still another aspect the present disclosure relates to a method for exchanging financial and product information between a plurality of automotive dealer computer systems operated by a plurality of independent automotive dealers, and a plurality of remotely located, independent provider computer systems operated by independent product providers. The method may comprise providing a first data dictionary, included in each one of the dealer computer systems, that includes a plurality of data elements mapped to a plurality of variables used by its respective said dealer computer system. The method may also involve providing a provider network including a computer and a second data dictionary system. The second data dictionary system may include the data elements used by each one of the dealer computer systems registered with the provider network. The provider network may be in communication with the dealer computer systems over a wide area network (WAN) and able to query each of the provider computer systems for at least one of financial and product information. The method may further involve using a dealer system integration (DSI) apparatus to interface a dealer system computer, over the WAN, to the provider network. The DSI apparatus may be used to register each of the dealer computer systems with the provider network and to receive a first request for rates for a financial product from a first selected one of the product providers. The first request may be made by a first one of the dealer computer systems. The DSI apparatus may also be used to coordinate a receipt and transfer of the rates for the financial product to the first one of the dealer computer systems. The DSI apparatus may be used to receive a second request for a completed, specific form from a selected second one of the product providers along with required data for the form. The second request may be made by a second selected one of the dealer computer systems. The DSI apparatus may also be used to coordinate a receipt and transfer of the completed, specific form to the second dealer computer system. At least one of the dealer computer systems and the provider network may use the data dictionaries, when needed, to assist in completing a form required by a requested one of the dealer computer systems.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a high level block diagram of a Dealer System Integration Application Programming Interface System (hereinafter “DSI”) in accordance with one embodiment of the present disclosure being used to interface a plurality of point of system (POS) entities with a provider network, in this example the Provider Exchange Network (PEN), and where the PEN is in communication with a plurality of independent provider systems;

FIG. 1A is a high level block diagram illustrating the data element dictionary in use;

FIGS. 1B and 1C represent a list of exemplary data elements, as text, suitable for use in the present system and method;

FIG. 2 is a table of Use Cases that represent functions that the dealer system can perform using the DSI;

FIGS. 3-16 are tables illustrating operations and conditions associated with the various Use Cases listed in the table of FIG. 2;

FIG. 17 is a flowchart illustrating an information exchange between the DSI and the Provider Exchange Network (PEN) for form preparation, live e-contracting and batch e-contracting how the DSI, when dynamically obtaining rates for a particular product from PEN;

FIG. 18 is a flowchart illustrating the same operations discussed in FIG. 17 but for a request from the dealer system for fixed rates for a specific product;

FIG. 19 is a sequence diagram illustrating the same operations discussed in FIG. 17 but for a request from the dealer system for rates not received from PEN;

FIG. 20 is a table illustrating 18 different subroutine calls (i.e., methods) that may be used by the dealer system when carrying out the 14 Use Cases listed in FIG. 2;

FIGS. 21-24 are tables further illustrating the operations and variables used in connection with the 18 subroutine calls listed in FIG. 20;

FIG. 25 is a sequence diagram illustrating how the dealer system may use the DSI to perform dealer and product registration (Use Cases 1 and 2);

FIG. 26 is a sequence diagram illustrating how the DSI may be used in implementing the functions of rating, contracting and forms preparation (Use Cases 3, 7 and 9).

### DETAILED DESCRIPTION

The following description is merely exemplary in nature and is not intended to limit the present disclosure, application, or uses. It should be understood that throughout the drawings, corresponding reference numerals indicate like or corresponding parts and features.

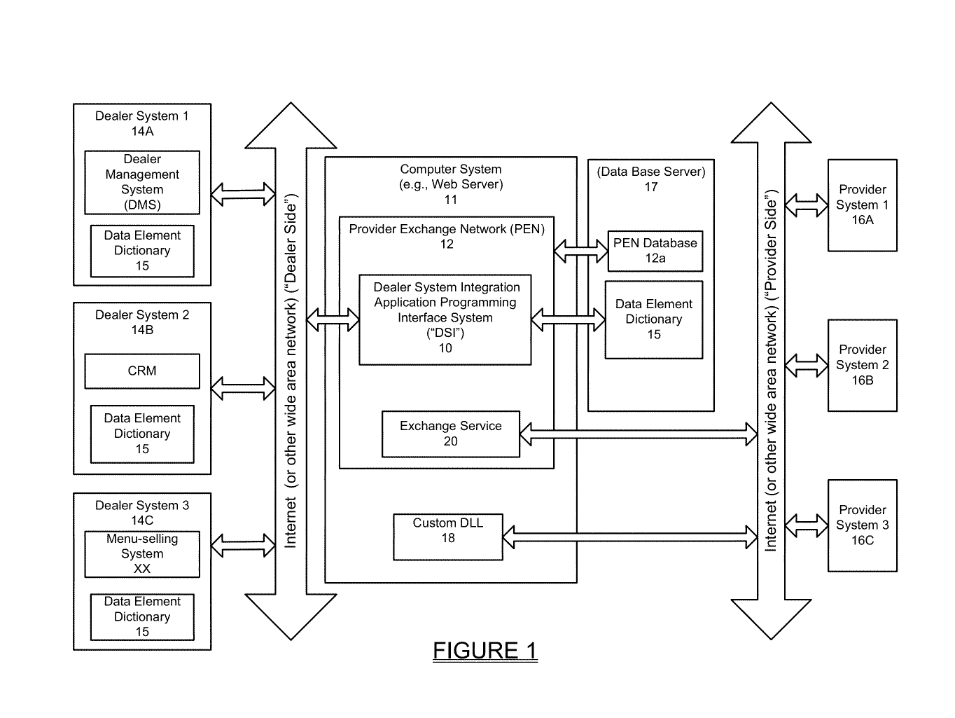

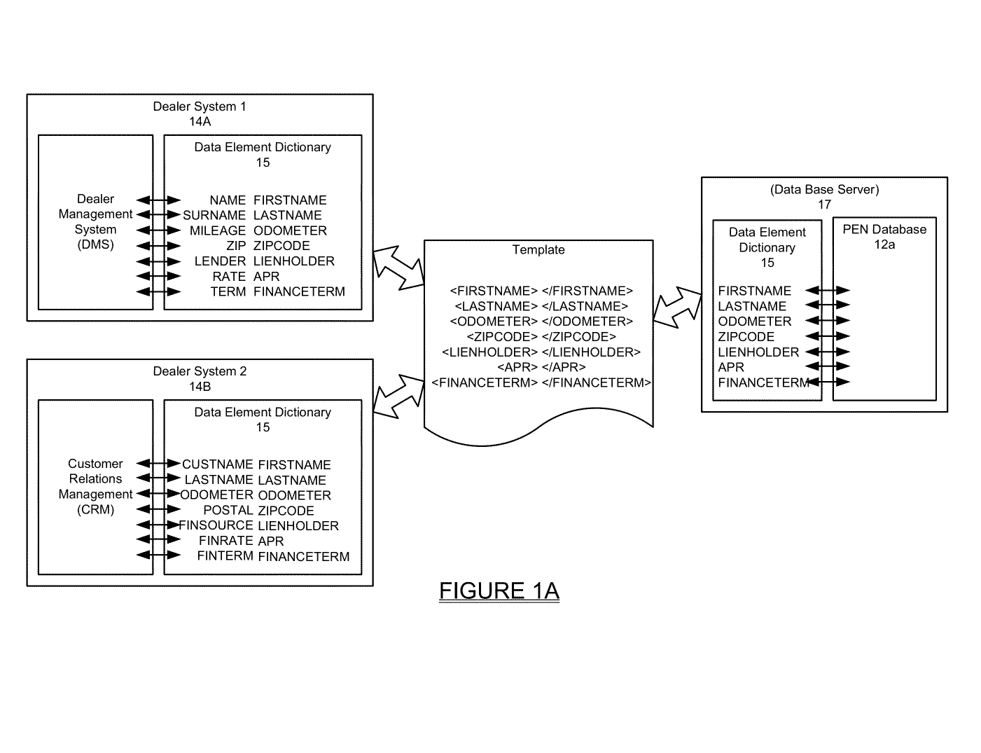

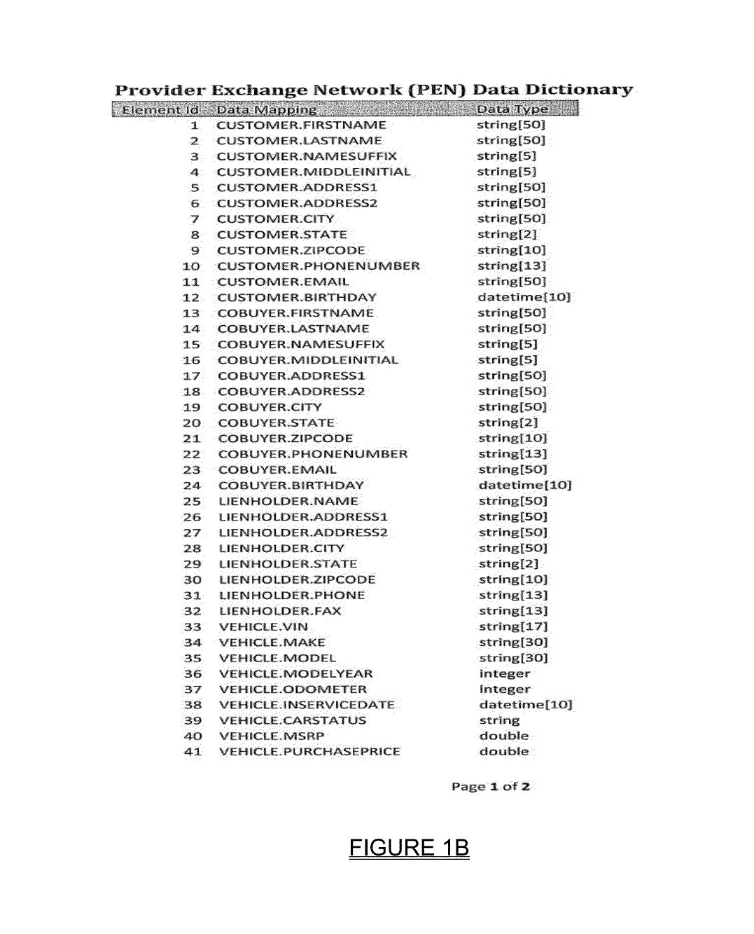

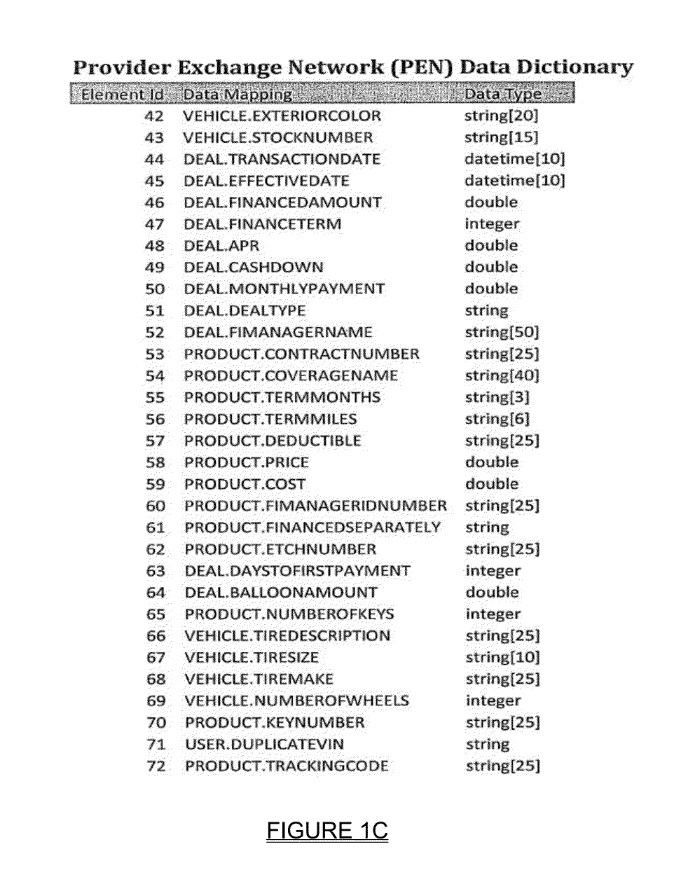

Referring to FIG. 1 there is shown a dealer system integration application programming interface apparatus or system 10 (hereinafter simply “DSI”) in accordance with one embodiment of the present disclosure. The DSI in this example forms an application programming interface (API) that is implemented in a computer system 11 system (e.g., a Web server) and is used to interface a provider network with a number of automotive dealer computers 14A, 14B and 14C (hereinafter simply “dealer system 14” or “dealer systems 14”). In this example the provider network is illustrated as the “Provider Exchange Network” (“PEN”) 12, and the DSI 10 runs on the PEN 12. The PEN 12 is a well known and successful provider network used by automotive dealers for interfacing with various independent provider systems 16A, 16B and 16C to obtain rates and quotations, various products and services, completed forms and contracts, and other information and documentation that may be useful or needed in connection with an automotive dealer's operations. In FIG. 1 only three dealer systems 14A-14C are illustrated, but it will be understood that is merely exemplary, and that a larger or smaller number of dealer computer systems may be accommodated using the DSI 10. Similarly, while only three provider systems 16A-16B are illustrated, it will be appreciated that a greater or lesser number of such systems may be accommodated by the PEN 12. It will also be appreciated that other provider networks may be used, and that the following description should not be interpreted as limiting the DSI 10 to use with only the PEN 12. In practice the DSI 10 may be used with other provider networks with little modification.

Each of the dealer systems 14A-14C use their respective computer system, whether it be a well known Dealer Management System (DMS) system, a CRM (Customer Relationship Management) system or a menu-selling system, to access the PEN 12 over a wide area network to communicate with each provider system 16A-16C using the DSI 10 as the interface. The connection between the dealer systems 14A-14C and the PEN 12 may be thought of as the “Dealer Side” Internet connection. In this example the wide area network is shown as the Internet although it will be appreciated that any other form of wide area network could be used. The Internet is used to enable the PEN 12 to communicate bidirectionally with each of the provider systems 16A-16C. For convenience, the connection between the PEN 12 and the provider systems 16A-16C may be thought of as the “Provider Side” Internet connection. The provider systems 16A-16C may each be in communication with PEN 12 through an intermediate system such as a custom dynamic link library (DLL) 18 or an exchange service 20. It is a principal advantage of the DSI 10 that rather than requiring a separate custom interface at each dealer system 14A-14C, the DSI 10 is able to function as an interface to PEN 12, and to the dealer systems 14A-14C. This is accomplished in part by a data element dictionary 15 that resides on the PEN database server 17, and a corresponding (i.e., preferably identical) data element dictionary 15 that is included at each dealer system 14. In this example the database server 17 forms a computer system that also has a PEN database 12a. Thus, the data element dictionaries represent all the data elements needed for use by each of the dealer systems 14A-14C. Each data element dictionary 15 is mapped to variables in its respective dealer system 14A-14C. The data element dictionaries 15, represent all the data elements that are needed for the dealer systems 14A-14C to complete a given contract. As will be explained further in the following paragraphs, each dealer system 14A-14C may access its data element dictionary 15 to identify the required data elements that are needed to fill out an XML template that it has received from the DSI 10 in response to a request to book a contract. The DSI 10 exposes uniform, standard data structures to each of the dealer systems 14A-140. Use of the data element dictionary is shown in FIG. 1A, an example of the text elements that may make up the data element dictionary 15 is shown in FIGS. 1B and 1C.

The PEN 12 is well known and presently used in the automobile dealer industry, and therefore will not be described in detail. Nevertheless, it is helpful to note that the PEN 12 is able to connect to a provider systems' rating service and pass rates through to any of the dealer systems 14A-14C based on any one of a VIN (vehicle identification number), a provider-specific model identifier, or a fixed selection of rates where a real time rating by VIN or by model is not available. PEN 12 may also assist with non-rated products, such as GAP insurance rates. PEN 12 also assists with form filling, such as providing completed forms in a PDF document based on information provided by a dealer system 14A-14C, as well as obtaining provider-hosted forms. PEN 12 may also issue contract numbers for contracts that it generates, and may assist with supplying prompted text on forms and contracts, as well as archival of completed and incomplete forms. The foregoing is just a sampling of operations that PEN 12 may assist with or control.

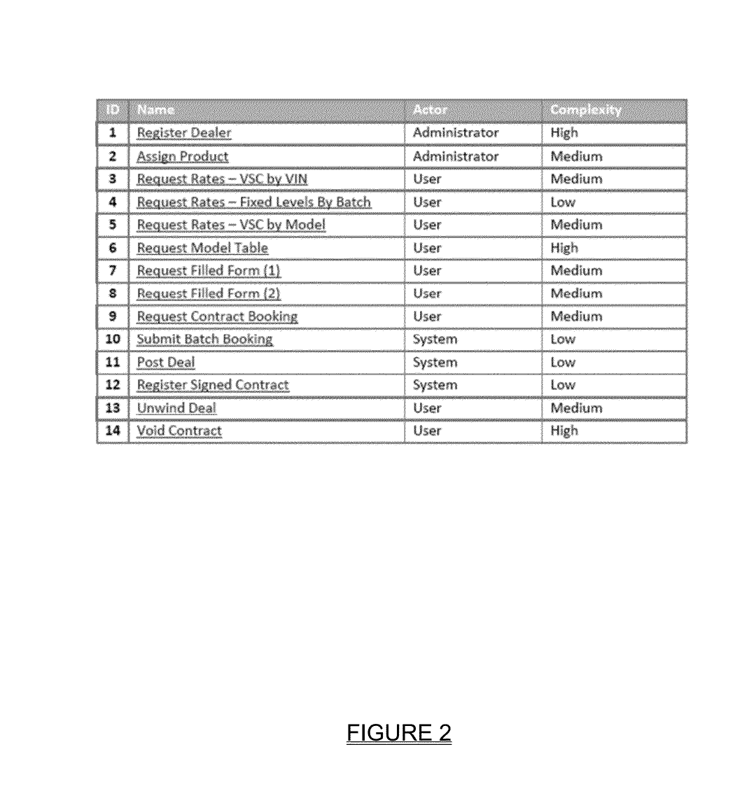

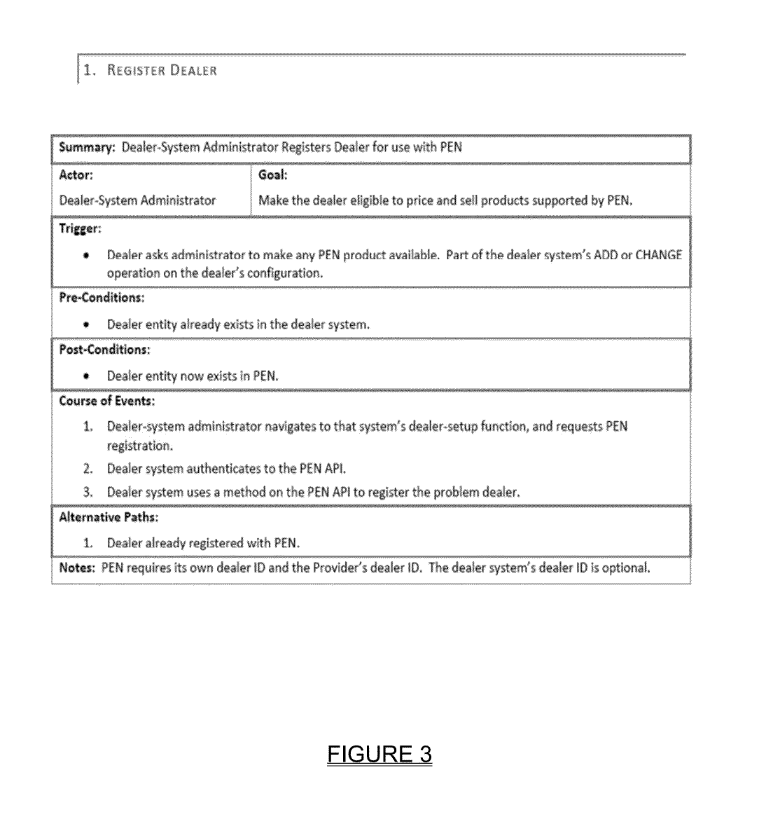

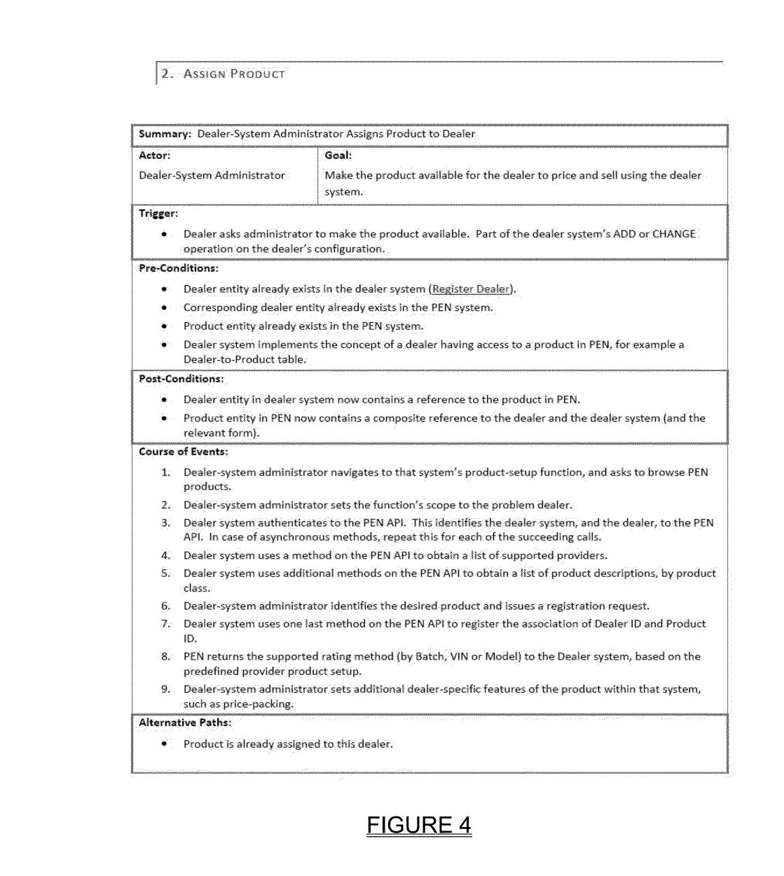

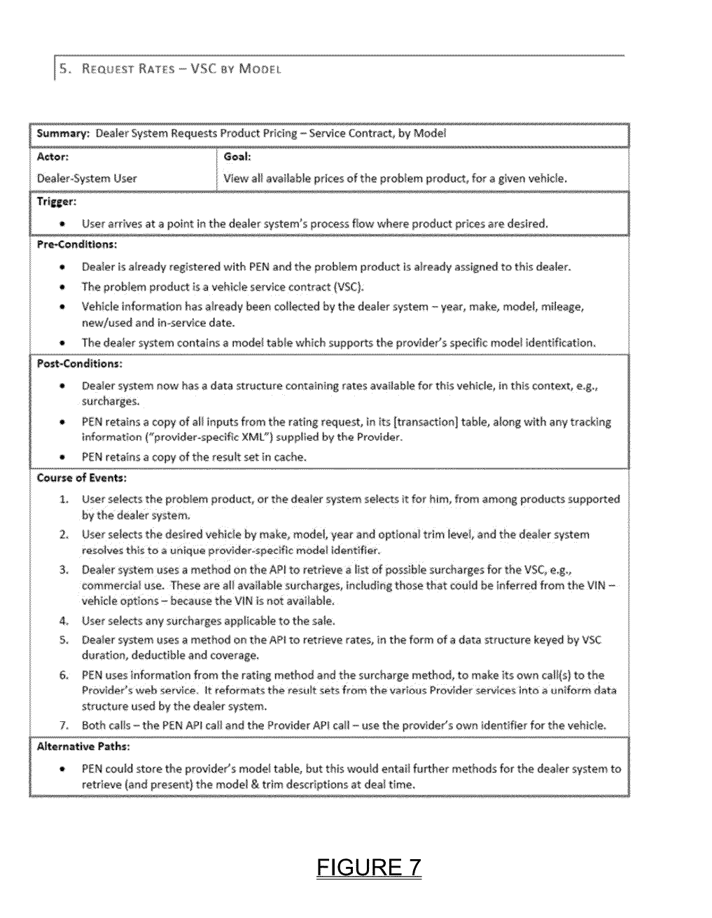

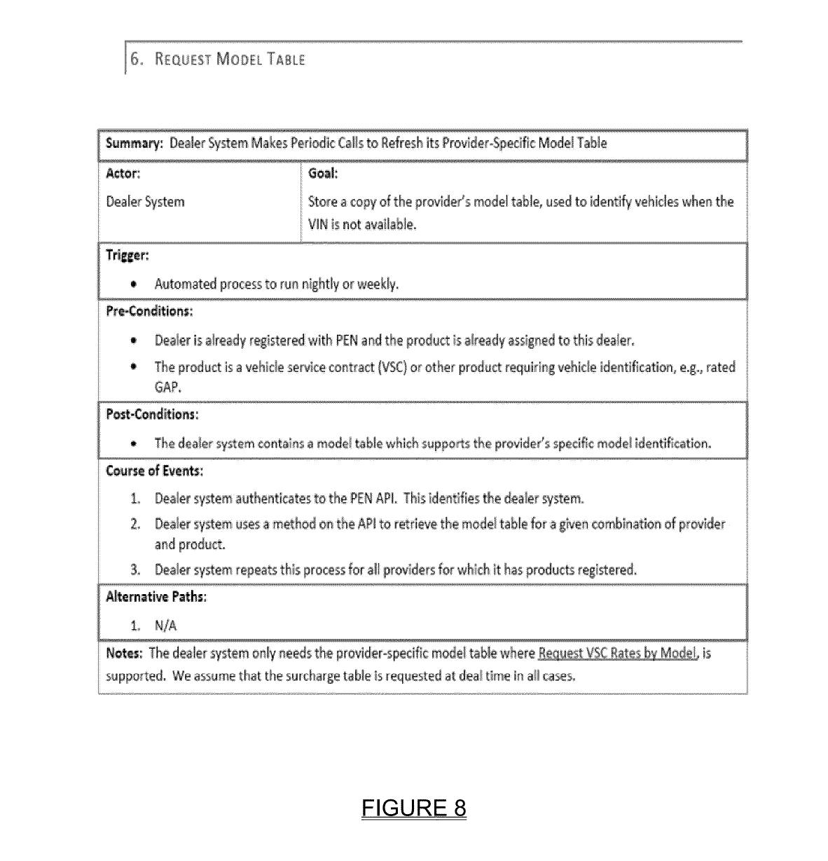

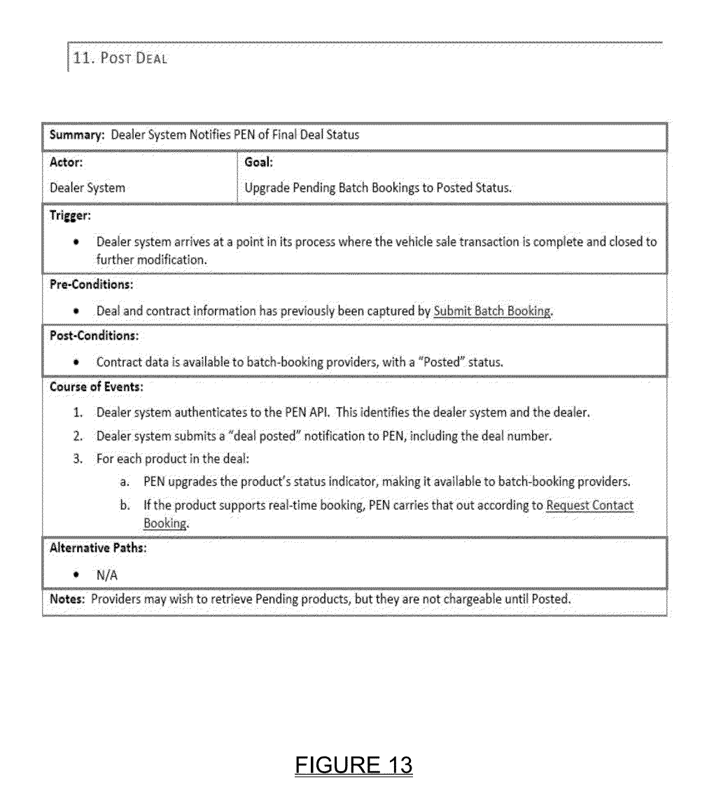

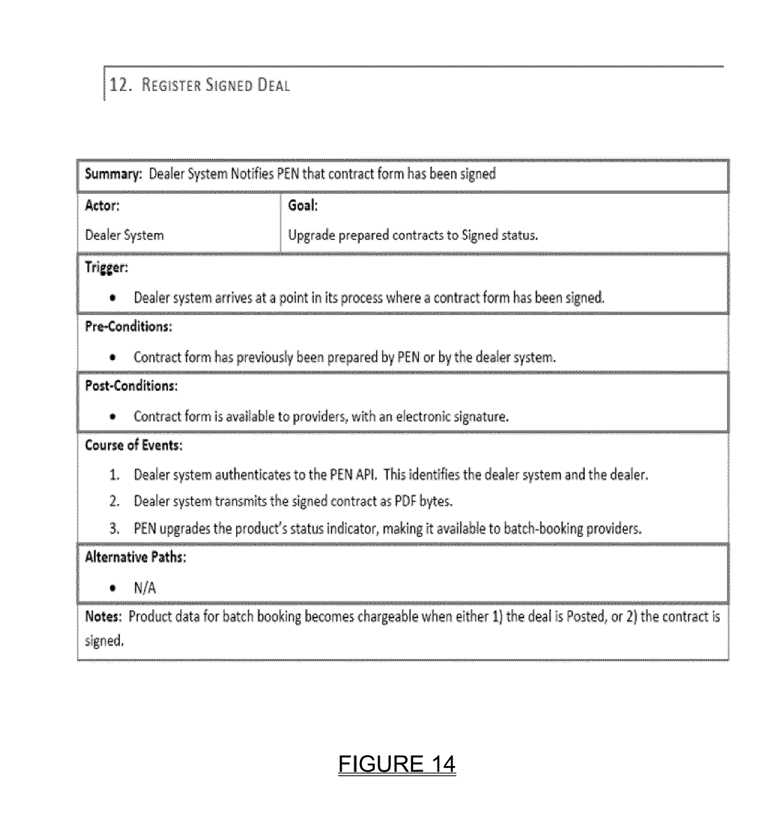

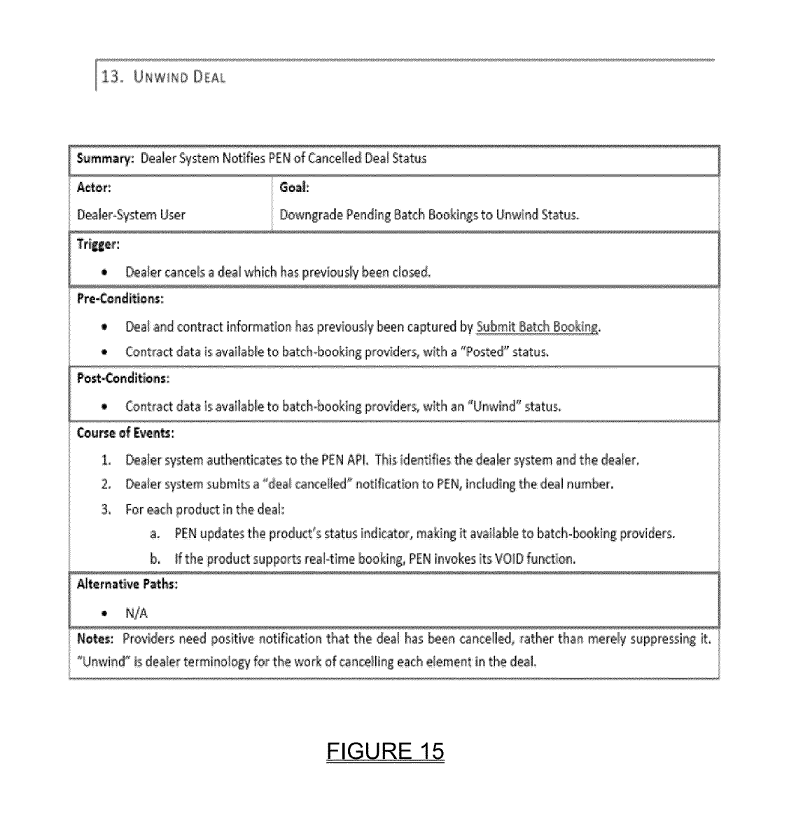

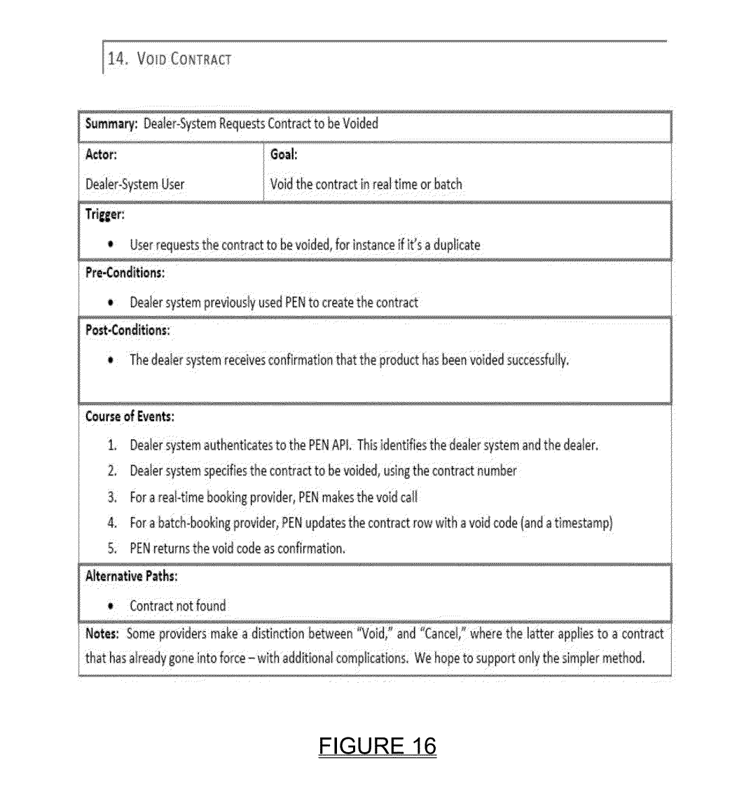

Referring to FIG. 2 a chart is provided illustrating various “use cases” that are supported by the DSI 10. FIGS. 3-16 represent descriptions of each of the use cases listed in FIG. 2.

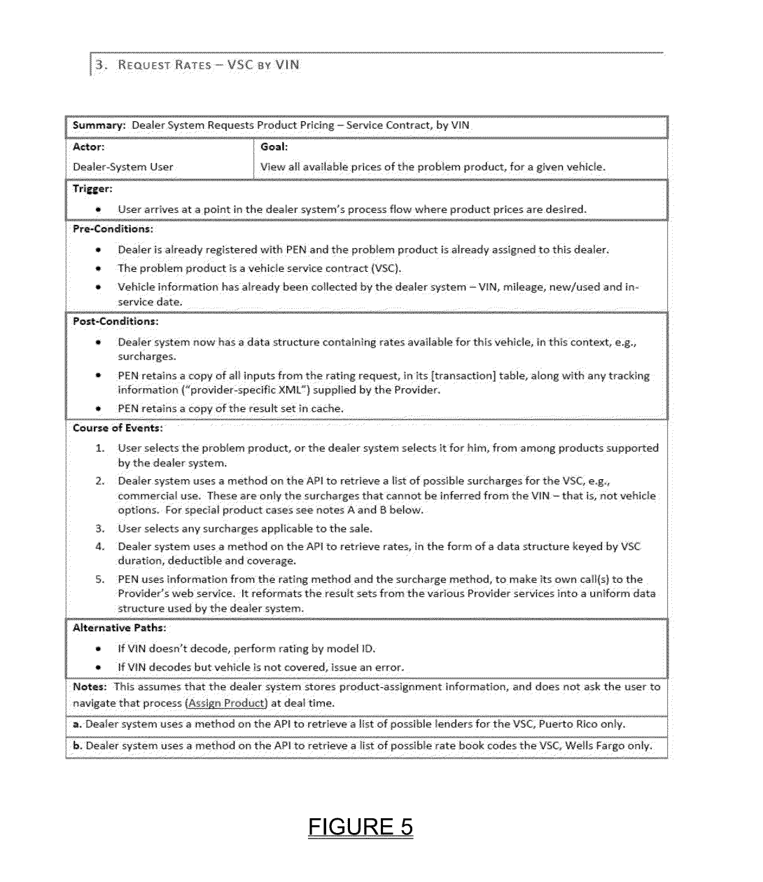

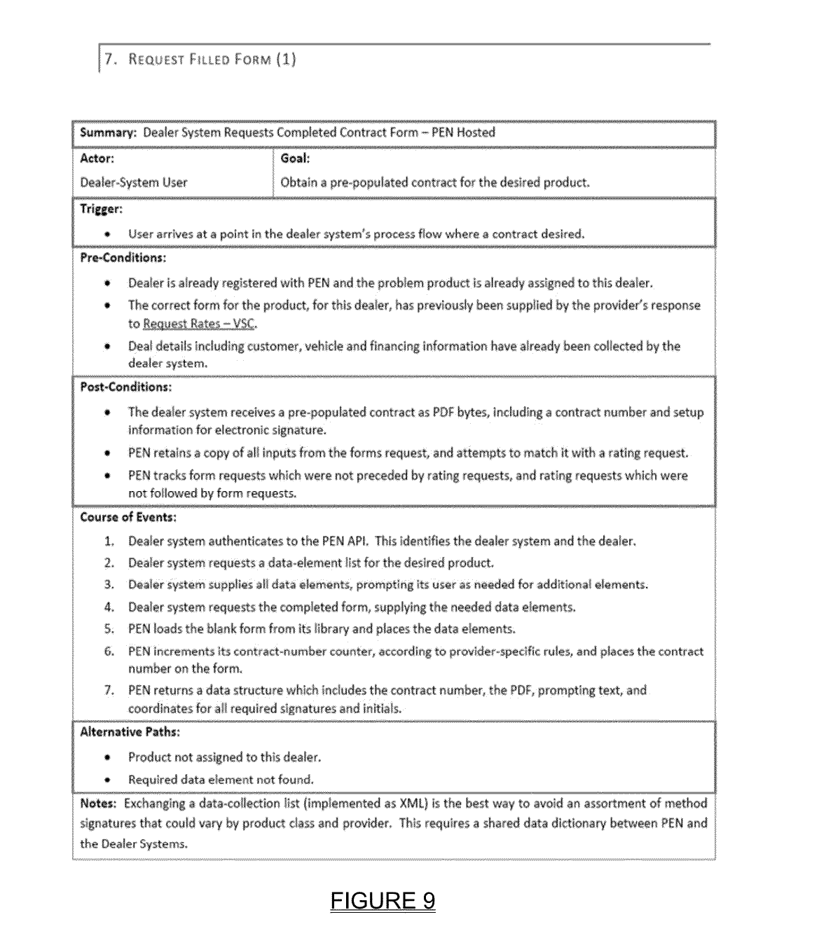

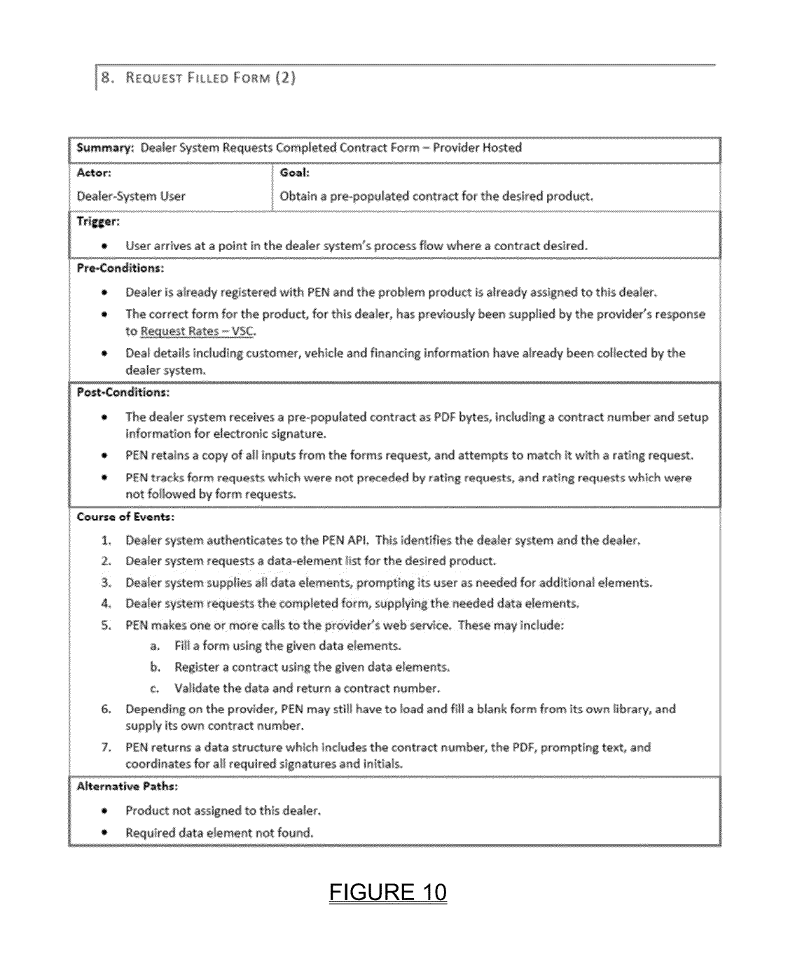

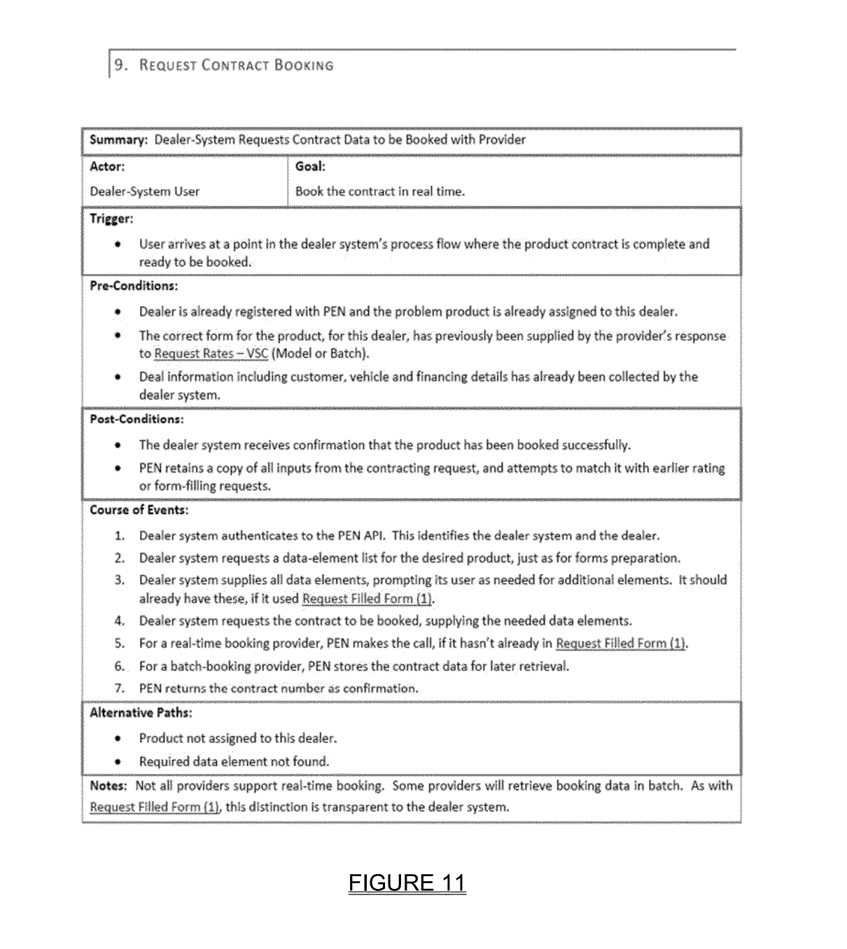

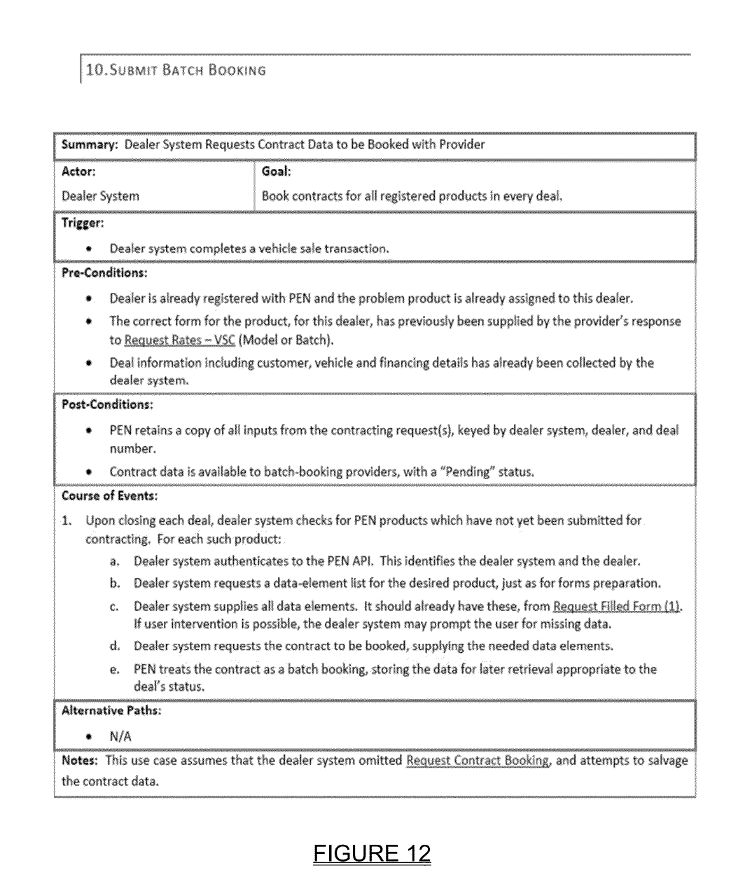

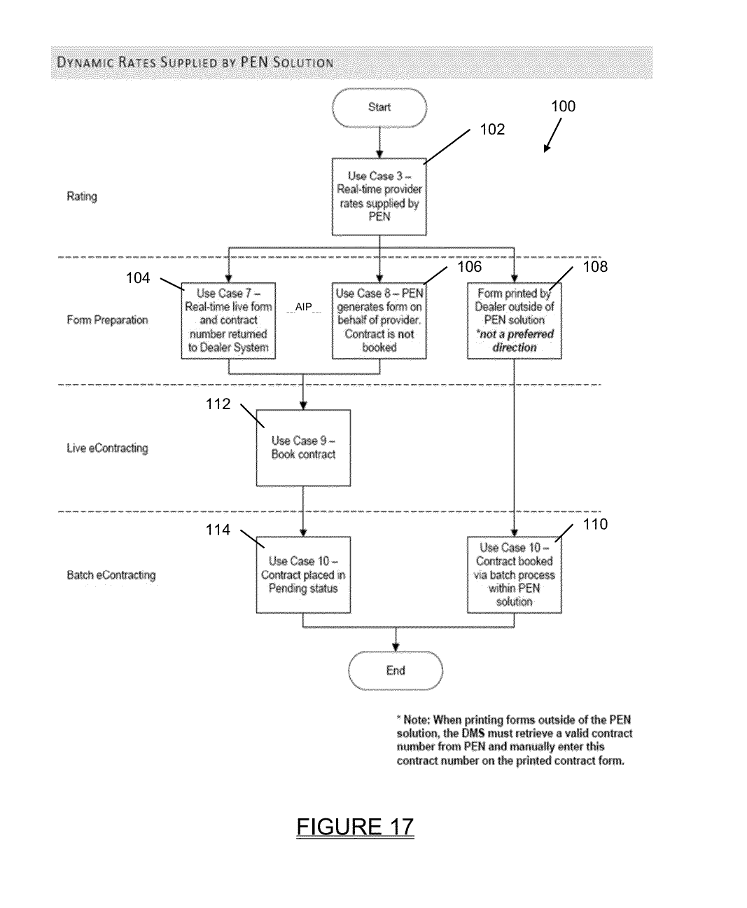

Referring to FIGS. 17-19, the flowcharts presented in these figures illustrate examples of how the DSI 10 is used to interact with the PEN 12 and a given one of the dealer systems 14 to perform important operations relating to 1) obtaining a Provider Product Rating, assisting with form preparation and contract origination. In FIG. 17, flowchart 100 show that Use Case 3 (from FIG. 5) is performed at operation 102 in response to a specific dealer system 14A, 14B or 14C requesting rates (i.e., product pricing) for a product for a given vehicle. At operation 104 Use Case 7 (FIG. 9) may be performed to return a “live” form and contract number in real time to the dealer system 14. Alternatively, operation 106 may be performed using Use Case 8 (FIG. 10) to generate a form on behalf of the provider system 16, but where a contract is not booked. Still further, another alternative operation 108 may be performed where a form is printed by a dealer system 14 with no assistance from the DSI 10 or PEN 12. In that event operation 110 is performed where the contract is made available via the Exchange Service (FIG. 1, item 20) to be booked by the provider using a batch process. If either of operations 104 or 106 are performed, then operation 112 is performed, which involves carrying out Use Case 9 (FIG. 11) to book the contract. At operation 114, using Use Case 10 (FIG. 12), the Contract may be placed in “Pending” status until the dealer system changes the status to “Signed” or “Posted” as in use cases 12 and 11 respectively.

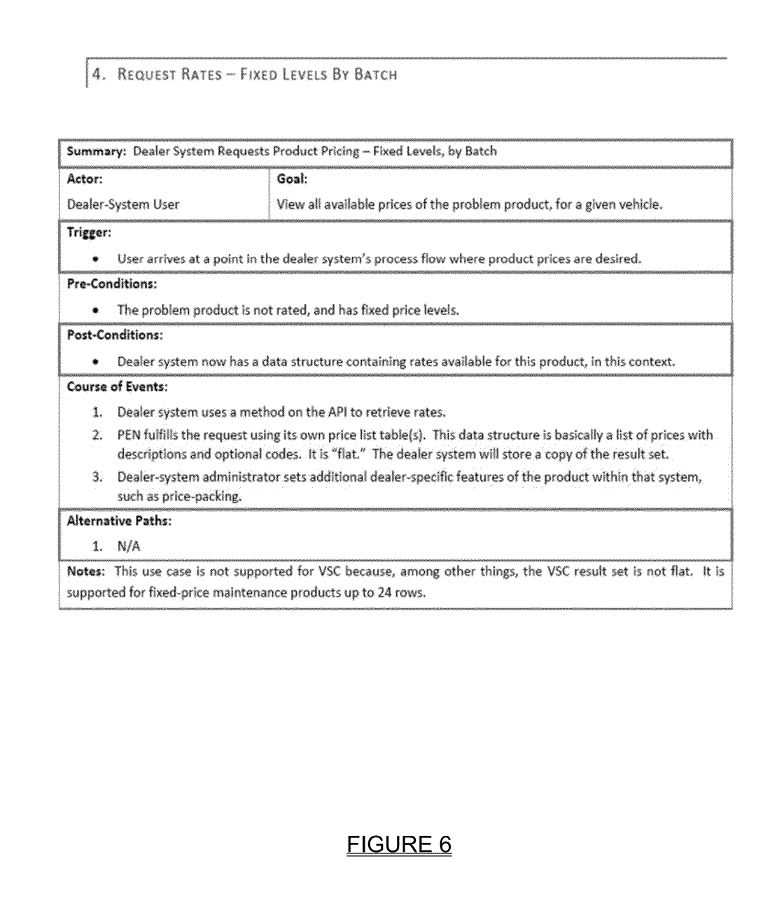

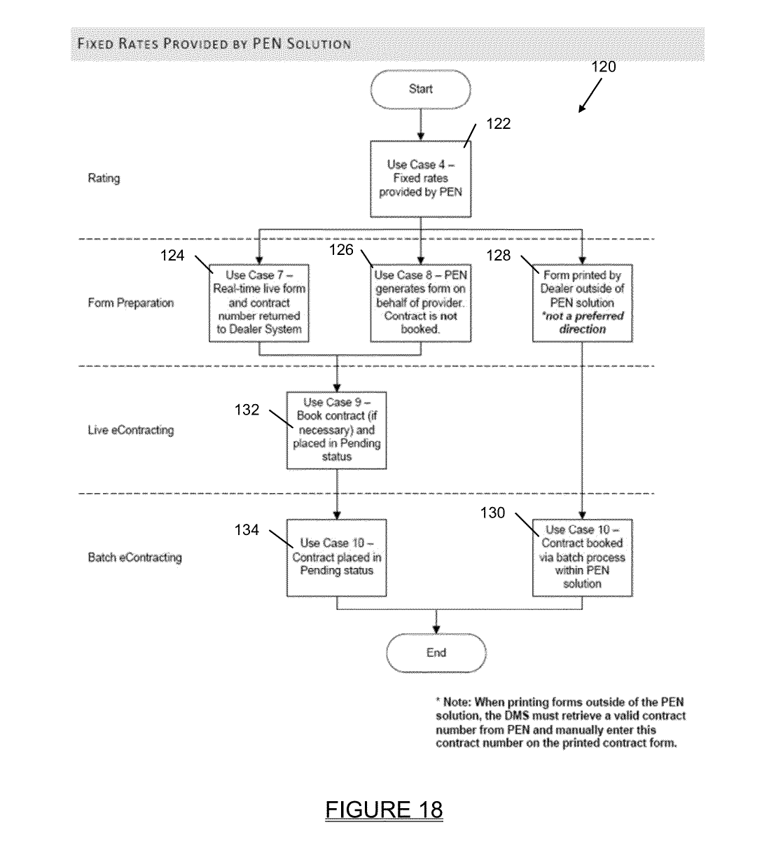

FIG. 18 shows a flowchart 120 illustrating how fixed rates may be provided using the DSI 10 and the PEN 12. This sequence of operations is somewhat similar to that described in connection with FIG. 17 and involves initially performing operation 122 to execute Use Case 4 (FIG. 6) to obtain fixed rates (e.g., prices) for a desired product. It will be appreciated that fixed-rate products in this example do not depend on the vehicle. Any one of operations 124, 126 or 128, which are identical to operations 104, 106 and 108, respectively, may then be performed. If operation 128 is performed, then Use Case 10 is executed at operation 130 (the same as operation 110). If either of operations 124 or 126 are performed, then operation 132 and 134 are performed, which are the same as operations 112 and 114, respectively from FIG. 17.

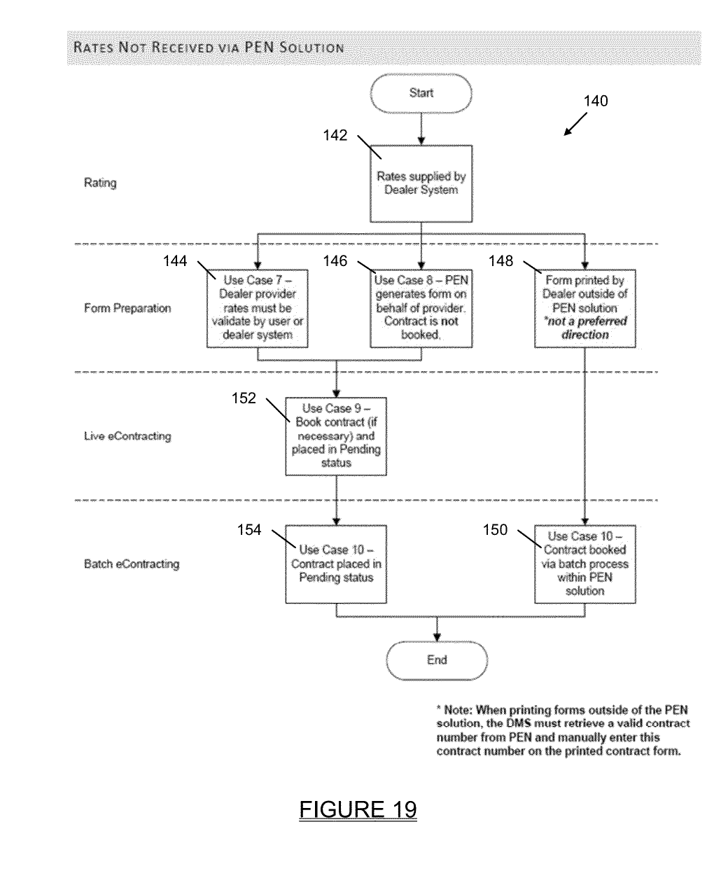

FIG. 19 shows a flowchart 140 that illustrates operations performed when rates are not received via the PEN 12 solution. At operation 142 rates for a given product are supplied by the dealer system 14. Then one of operations 144, 146 or 148 may be performed. Operation 144 involves performing Use Case 7 (FIG. 9) where the rates supplied by the dealer system 14 must be validated by a user or by the dealer system 14 If operation 146 is performed, this involves executing Use Case 8 (FIG. 10) in which the PEN 12 generates the needed form on behalf of the provider system 16. The contract is not booked. If operation 148 is performed, this involves the dealer system 14 printing the needed form without assistance from the DSI 10 or the PEN 12. If operation 148 is performed, then the dealer system may subsequently perform operation 150 to execute Use Case 10 (FIG. 12) to book the contract via a batch process using the DSI 10 and the PEN 12. If either of operations 144 or 146 are performed, then operations 152 (executing Use Case 9; FIG. 11) and 154 (executing Use Case 10; FIG. 12) may be performed to book the contract and place the contract in “Pending” status.

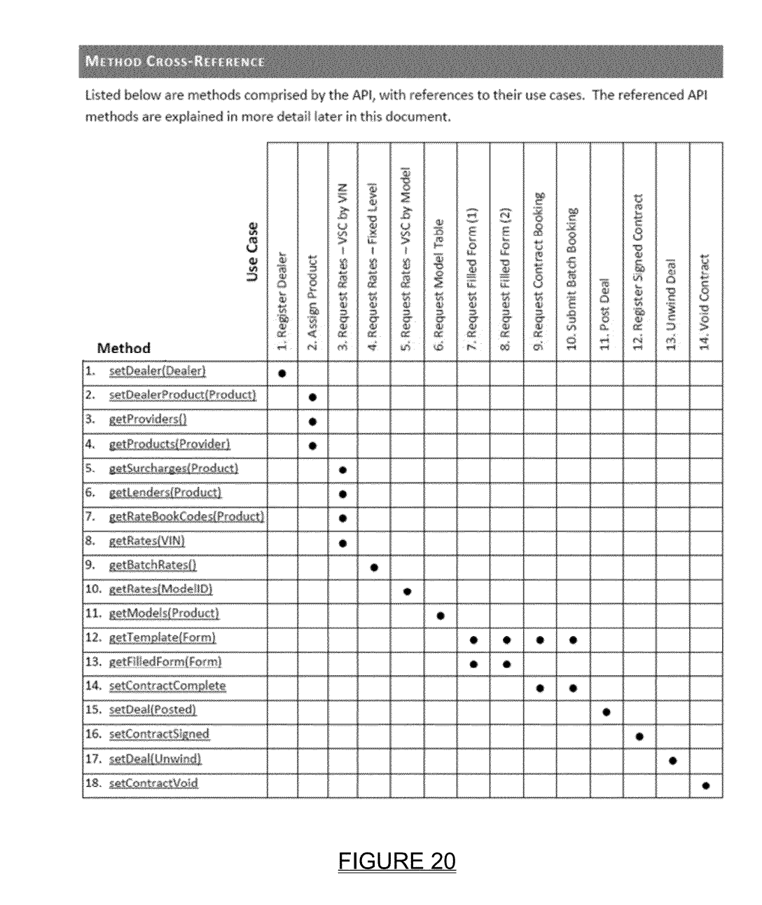

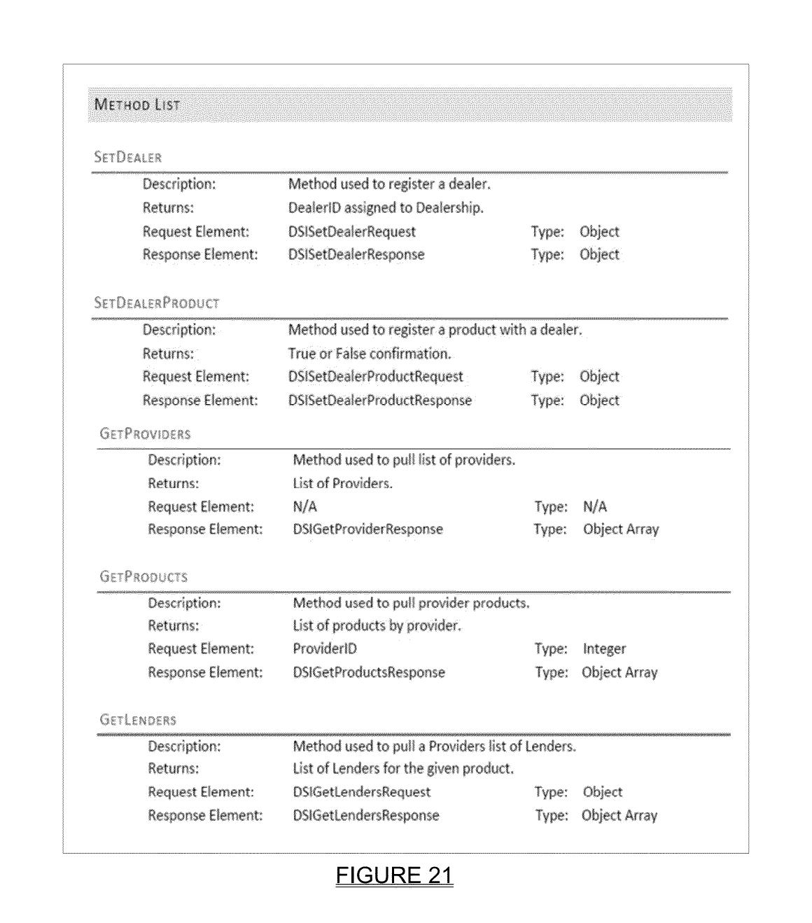

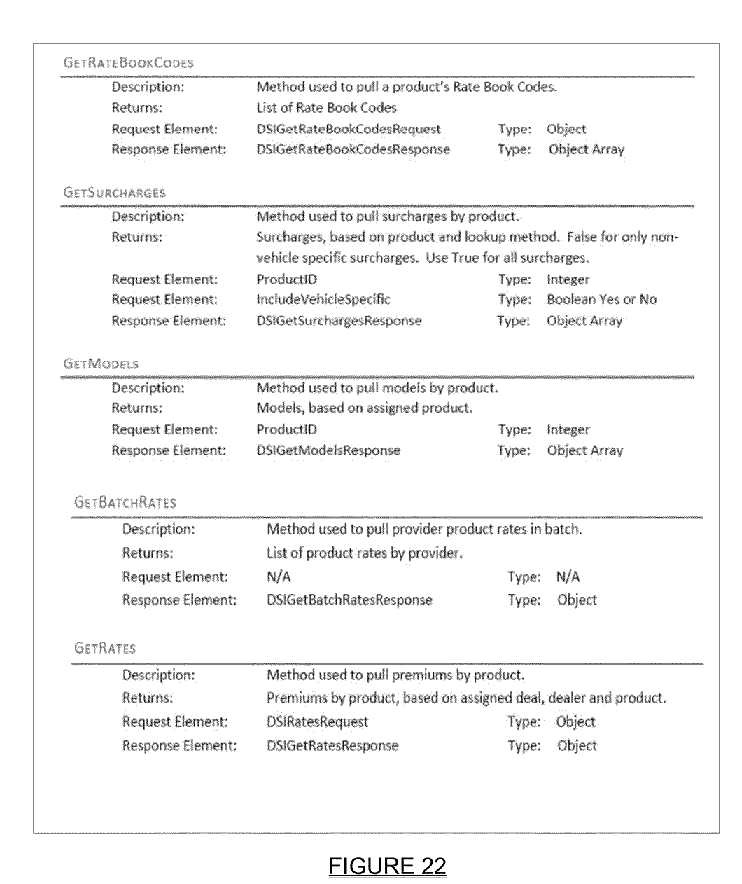

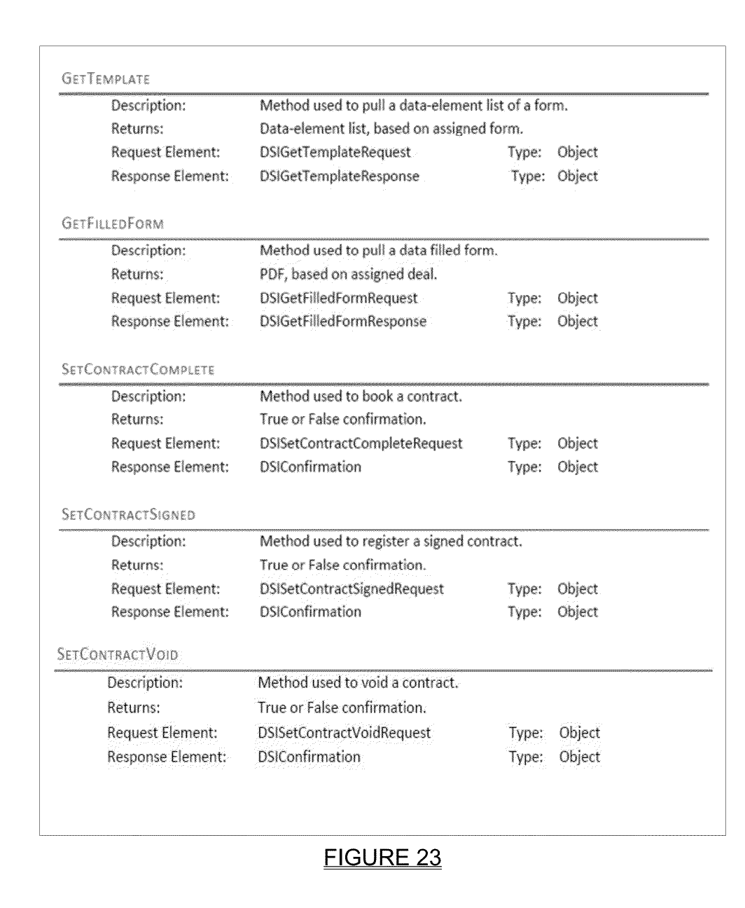

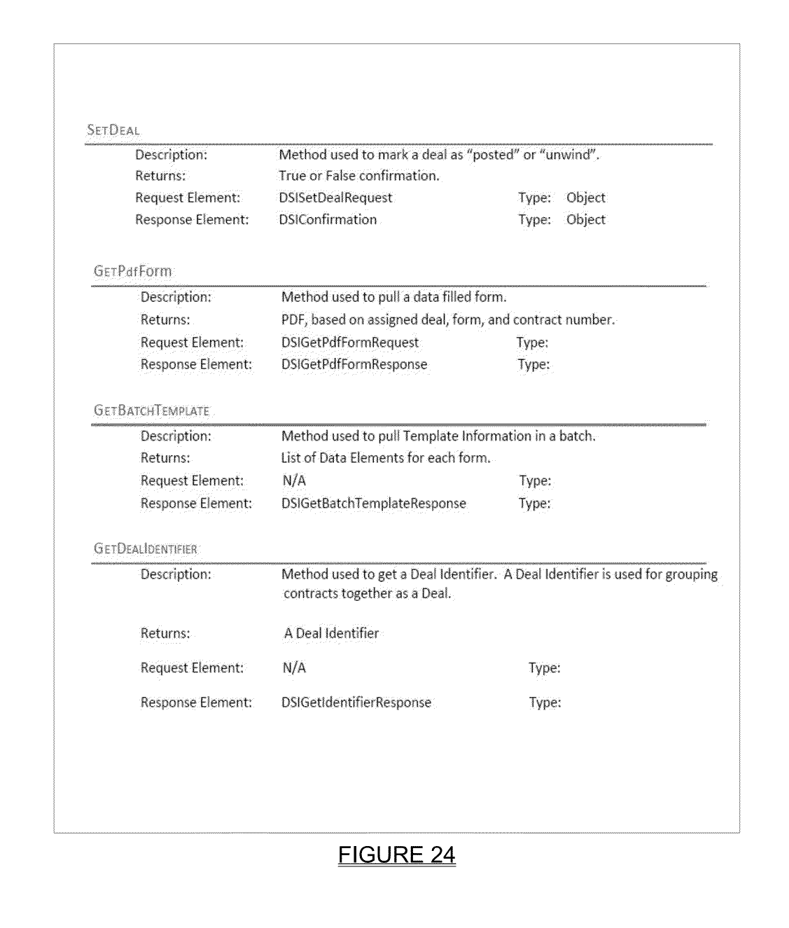

Referring now to FIG. 20 a table is shown that correlates which one(s) of the 18 specific methods (e.g., subroutine calls) that the DSI 10 is capable of performing are performed by the DSI 10 when carrying out each one of the 14 Use Cases shown in FIG. 2. It will be noted that certain ones of the 18 methods are used in several different ones of the Use Cases. For example, method number 12 in the table of FIG. 20, “getTemplate(Form)”, is used when executing any one of Use Cases 7-10 listed in FIG. 2. FIGS. 21-24 describe details of the 18 methods shown in FIG. 20.

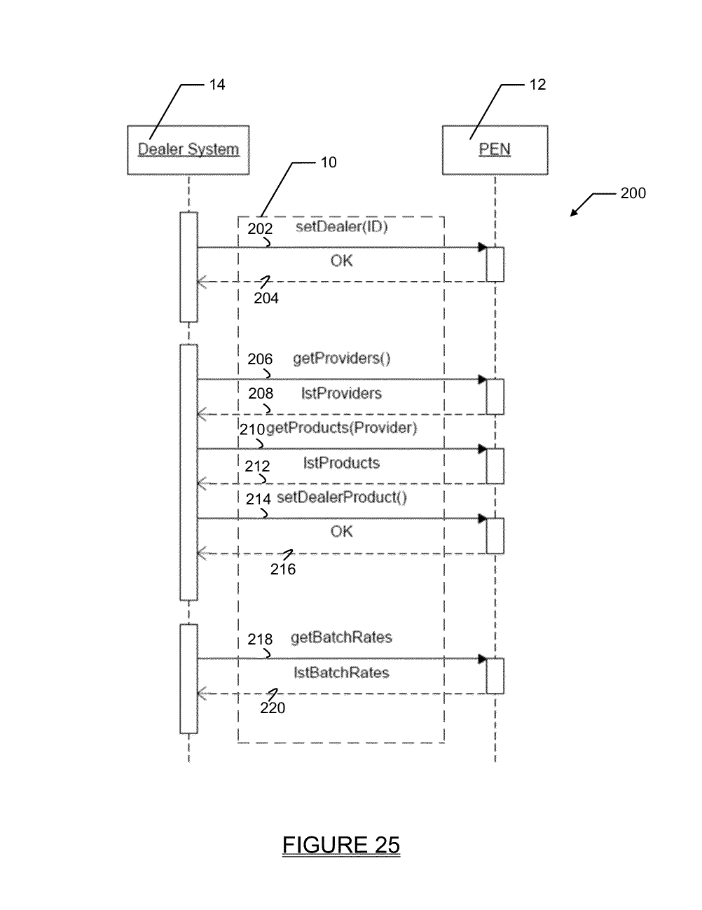

In FIG. 25, a sequence diagram 200 is shown for a dealer system 14 and a product registration. In this diagram, the DSI 10 is represented as the sequence of methods used by the dealer system to implement use cases 1, 2, and 4. Initially at operation 202 method 1 (setDealer(ID)) is performed and the DSI 10 sends the registration request to the PEN 12. The PEN 12 returns an acknowledgement at operation 204 which passes through the DSI 10 back to the particular dealer system 14 being registered with the PEN 12. At operation 206 the “getProviders( )” method is used to pull a list of provider systems 16 that are available for the dealer system 14 to access. At operation 208 the list of available dealer systems 16 is provided by the PEN 12 to the DSI, 10 which in turn provides the list to the dealer system 14 requesting same. At operation 210 the “getProducts(Provider)” method is executed whereby the dealer system 14 requests a list of products available from a given provider to be provided by the PEN 12, while using the DSI 10 to make the request to the PEN 12. At operation 212 the PEN 12 responds to the DSI 10 by providing the requested list of products, which the DSI 10 forwards to the dealer system 14 making the request. At operation 214 the dealer system 14 executes the “setDealerProduct( )” method which is a request by the dealer 14 for the PEN 12 to register a specific product with the dealer system 14. At operation 216 the PEN 12 returns an acknowledgement to the DSI 10, which in turn forwards the acknowledgement to the dealer system 14, that the registration has been completed. At operation 218, the dealer system 14 uses the “getBatchRates” method of the DSI 10 to pull provider product rates in batch format. The DSI 10 executes this method to generate the needed request to the PEN 12. The PEN 12 then returns a list of the batch rates to the DSI 10 at operation 220 which is then transmitted by the DSI 10 to the dealer system 14 making the request.

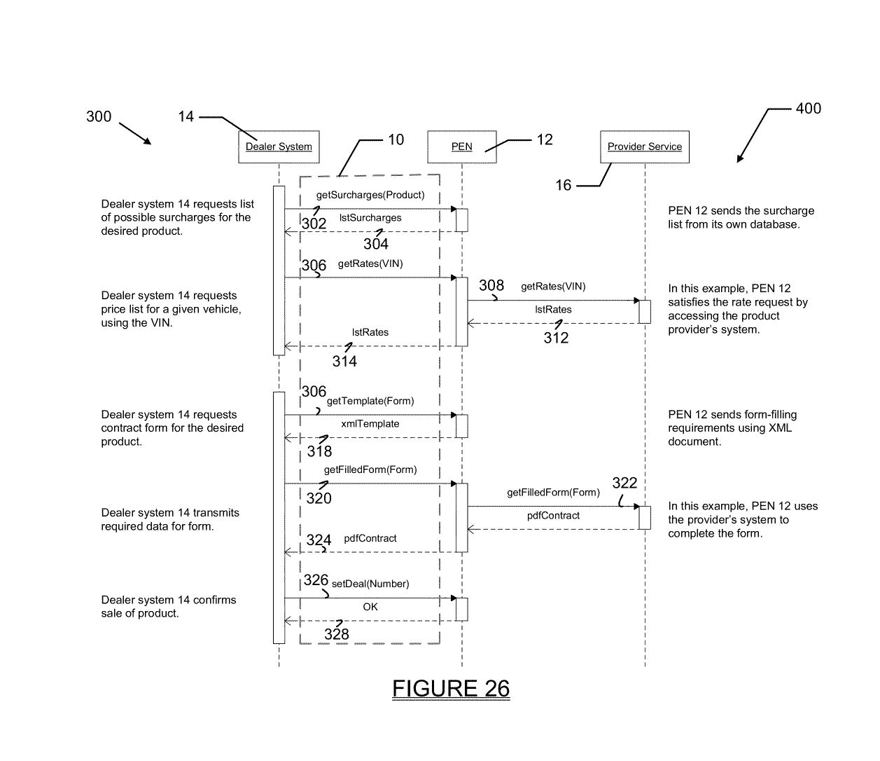

Referring to FIG. 26 shows a sequence diagram 300 that illustrates important operations that are performed during rating, contracting and forms preparation (use cases 3, 8 and 11). In this example a contract is booked during forms preparation and must be voided later unless confirmed by the dealer system 14. Initially at operation 302 the dealer system 14 makes a “getSurcharges(Product)” call to the DSI 10 to pull a list of surcharges for a specific product. The DSI 10 in turn contacts the PEN 12 with this request. The PEN 12 obtains the surcharges list from its own database 12a and forwards the list back to the DSI 10, as indicated at operation 304, which then forwards the list on to the dealer system 14. Alternatively, the PEN 12 may obtain the surcharge list from the provider's database. The role of the DSI 10 is to mask details of PEN 12 operation such that the dealer system only needs to be aware of the DSI

At operation 306 the dealer system 14 submits a “getRates(VIN)” call to the DSI 10. This is a call to pull premiums for a specific product based on a specific VIN. The DSI 10 forwards this request to the PEN 12 which makes this request to provider system 16 at operation 308. At operation 310 the provider system 14 returns the premiums from the provider system 16 and returns a list of the premiums at operation 312 to PEN 12. At operation 314 the PEN 12 provides the list of premiums to the DSI 10, which in turn provides the information to the dealer system 14.

At operation 316 the dealer system 14 issues a “getTemplate(Form)” call to the DSI 10 to request a form for a desired contract. The DSI 10 presents this call to PEN 12, which responds by sending form filling requirements using an XML template (i.e., document), to the dealer system, as indicated at operation 318. The form filling requirements in the XML template instruct the dealer system 14 what data elements to pull from its data element dictionary 15 in order to correctly populate the template.

At operation 320 the dealer system 14 makes a “getFilledForm(Form)” call to the DSI 10, which is a request to pull a specified form filled with the required data. In this example the dealer system 14 is transmitting the data required for the form and instructing PEN 12 to populate the requested form. The DSI 10 presents the request and the data to the PEN 12. The PEN 12 contacts the provider system 16 at operation 322 with a “getFilledForm(Form)” request for the specified form, in this example a contract, to book the contract. At operation 324 the web service of the provider system 16 completes the contract using the data provided from PEN 12 and returns the contract in a particular form, for example in PDF form. PEN 12 then provides the filled out contract in PDF form to the dealer system 14 at operation 324.

At operation 326 the dealer system 14 issues a “setDeal(Number)” call using the DSI 10 to PEN 12, which confirms the sale of the product represented in the just-received contract and reports the identification number (“deal number”) issued by the dealer system 14. At operation 328, PEN 12 acknowledges the dealer number setting.

In the operations discussed above for FIG. 26, depending on the product, product rating may be performed using Use Cases 3 or 4 (FIG. 5 or 6). Some provider systems use web rating to identify the desired contract form, or to transmit a tracking string known as “provider-specific XML”. Again, depending on the product, forms may be prepared in Use Cases 7 or 8 (FIG. 9 or 10). It is also possible for the dealer system 14 to use a different approach, such as pre-printed contract stock, thus skipping PEN 12 entirely. Not having prepared the forms, PEN 12 is deprived of an important source of contract data, and option is therefore less desirable than having PEN 12 prepare the contract form.

Data requirements to book a given contract may vary widely, within a universe of (at the present time) roughly about 300 data elements. To avoid a proliferation of methods with various signatures based on contract type, the DSI 10 uses the data collection list, or “template”, mentioned above. In this example the DSI 10 implements an XML template or document. The dealer system 14 may call a single method (subroutine call), passing a product identifier to the DSI 10. The DSI 10 may respond with an empty XML document back to the dealer system 14, representing the data elements needed to process the given product. The dealer system 14 then fills in the XML template by inserting a value for each XML tag, and returns it as an argument for subsequent booking methods. The dealer system 14 may be programmed to recognize and interpret the XML tags according to its data dictionary 15 which it shares with PEN 12. The data dictionary 15 is mapped to variables in the dealer system 14. New products can be added to PEN 12 without recompiling either system as long as the data elements are already present in the data dictionary. New products may be added regularly to PEN 12, and mapped to the data dictionary in both PEN 12 and in the dealer system 14, from which the PEN 12 can thereafter generate a new template dynamically on request.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. An apparatus for exchanging financial and product information between a plurality of automotive dealer computer systems operated by a plurality of independent automotive dealers, and a plurality of remotely located, independent provider computer systems operated by independent product providers, the apparatus comprising:
a provider network including a computer and a first data dictionary, the provider network being in communication with the dealer computer systems over a wide area network (WAN) and able to query each of the provider computer systems for at least one of financial and product information;
a second data dictionary, included in each one of the dealer computer systems, the second data dictionary system including the data elements used by each one of the dealer computer systems registered with the provider network and mapped to a plurality of variables used by its respective said dealer computer system;
a dealer system integration (DSI) apparatus for interfacing each said dealer computer system, over the WAN, to the provider network, the DSI apparatus being configured:
to register each said dealer computer system with the provider network;
to receive a first request for rates for a financial product from a first selected one of the product providers, the first request being made by a first one of the dealer computer systems, and to coordinate a receipt and transfer of said rates for said financial product to said first one of the dealer computer systems;
to receive a second request for a completed, specific form from a selected second one of the product providers along with required data for the form, the second request being made by a second selected one of the dealer computer systems, and to coordinate a receipt and transfer of the completed, specific form to the second dealer computer system; and
wherein at least one of the dealer computer systems and the provider network use the data dictionaries, when needed, to assist in completing a form required by a requested one of the dealer computer systems.

2. The apparatus of claim 1, wherein the provider network is further configured to:
receive a request for a specific form from at least one of the first and second dealer computer systems;
to generate an extensible markup language (XML) template in response to the request for the specific form, the XML template having a plurality of XML tags representing data elements that need to be filled in by the at least one dealer computer system;
to transmit the XML template back to the at least one dealer computer system that made the request for the specific form; and
to receive a completed XML template back from the at least one dealer computer that includes a value for each XML tag; and
to forward the completed XML template to the provider network.

3. The apparatus of claim 1, wherein the rates comprise surcharges for a particular financial product specified by a first selected one of the dealer computer systems.

4. The apparatus of claim 1, wherein the request for rates comprises a request for rates for a vehicle identified by a specific Vehicle Identification Number (VIN).

5. The apparatus of claim 1, wherein the DSI apparatus is adapted to receive a Portable Document Format (PDF) document representing a completed contract and to forward the PDF document to the second selected one of the dealer computer systems.

6. The apparatus of claim 1, wherein:
the first selected one of the dealer computer systems is adapted to request fixed rates for a given financial product from at least one of the dealer computer systems;
the DSI apparatus is configured to relay the request for fixed rates to the provider network;
the provider network is configured to obtain the fixed rates for the given financial product from at least one of the provider computer systems and to return the obtained fixed rates to the DSI apparatus; and
the DSI apparatus is able to return the obtained fixed rates to the selected one of the dealer computer systems.

7. The apparatus of claim 1, wherein the DSI apparatus is further configured to assist with electronic contract booking of a contract transmitted between one of the first and second selected dealer computer systems and one of the provider computer systems.

8. The apparatus of claim 7, wherein the DSI apparatus is further configured to forward a request for a contract number for the contract to the provider network and to return a contract number for the contract to the one of the first and second selected dealer computer systems.

9. An apparatus for exchanging financial and product information between a plurality of automotive dealer computer systems and a plurality of remotely located, independent provider computer systems, the apparatus comprising:
a first data dictionary, included in each one of the dealer computer systems, that includes a plurality of data elements mapped to a plurality of variables used by its respective said dealer computer system;
a provider network including a computer and a second data dictionary system, the second data dictionary system including the data elements used by each one of the dealer computer systems registered with the provider network;
a dealer system integration (DSI) apparatus for interfacing a dealer system computer, over the WAN, to the provider network, and the provider network being in communication with the dealer computer systems over a wide area network (WAN) and able to query each of the provider computer systems for at least one of financial and product information, the DSI apparatus further being configured:
to receive a request for at least one of said financial or product information from any one of the dealer system computers;
to use an extensible markup language (XML) template having at least one XML tag representing a field where the dealer system computer of the one dealer system is to fill an appropriate data element from its respective said data element library;
to transmit the XML template back to the one dealer system computer that made the request;
to receive the XML template back from the one dealer system after the one dealer system has filled in the appropriate data elements corresponding to the at least one XML tag, to thus form a completed XML template; and
to transmit the completed XML template to the provider network for subsequent action by the provider network.

10. The apparatus of claim 9, wherein the provider network further operates to forward the completed XML template to one of the provider computer systems designated by the one dealer computer system.

11. The apparatus of claim 9, wherein the DSI is configured to receive a request for rates for the financial product, and wherein the rates comprise surcharges for the financial product specified by the one dealer system.

12. The apparatus of claim 9, wherein the DSI is configured to receive a request for rates for the financial product, and wherein the request for rates comprises a request for rates for a vehicle identified by a specific Vehicle Identification Number (VIN).

13. The apparatus of claim 9, wherein the DSI apparatus is adapted to receive a Portable Document Format (PDF) document representing a completed contract from the provider network and to forward the PDF document to the one dealer computer system.

14. The apparatus of claim 9, wherein the DSI apparatus is further configured to assist with electronic contract booking of a contract transmitted between one of the dealer computer systems and the provider network.

15. The apparatus of claim 14, wherein the DSI apparatus is further configured to forward a request for a contract number for the contract to the provider network and to return a contract number for the contract to the one dealer computer system.

16. A method for exchanging financial and product information between a plurality of automotive dealer computer systems operated by a plurality of independent automotive dealers, and a plurality of remotely located, independent provider computer systems operated by independent product providers, the method comprising:
providing a first data dictionary, included in each one of the dealer computer systems, that includes a plurality of data elements mapped to a plurality of variables used by its respective said dealer computer system;
providing a provider network including a computer and a second data dictionary system, the second data dictionary system including the data elements used by each one of the dealer computer systems registered with the provider network, and the provider network being in communication with the dealer computer systems over a wide area network (WAN) and able to query each of the provider computer systems for at least one of financial and product information;
using a dealer system integration (DSI) apparatus to interface a dealer system computer, over the WAN, to the provider network;
using the DSI apparatus to:
register each said dealer computer systems with the provider network;
to receive a first request for rates for a financial product from a first selected one of the product providers, the first request being made by a first one of the dealer computer systems, and to coordinate a receipt and transfer of said rates for said financial product to said first one of the dealer computer systems;
to receive a second request for a completed, specific form from a selected second one of the product providers along with required data for the form, the second request being made by a second selected one of the dealer computer systems, and to coordinate a receipt and transfer of the completed, specific form to the second dealer computer system; and
wherein at least one of the dealer computer systems and the provider network use the data dictionaries, when needed, to assist in completing a form required by a requested one of the dealer computer systems.

17. The method of claim 16, further comprising using the provider network to:
receive a request for a specific form from at least one of the first and second dealer computer systems;
generate an extensible markup language (XML) template in response to the request for the specific form;
cause the XML template to include a plurality of XML tags representing data elements that need to be filled in by the at least one dealer computer system;
transmit the XML template back to the at least one dealer computer system that made the request for the specific form;
to receive a completed XML template back from the at least one dealer computer that includes a value for each XML tag; and
to forward the completed XML template to the provider network.

18. The method of claim 16, wherein the request for rates comprises making a request for rates for a vehicle identified by one of a specific Vehicle Identification Number (VIN) or a specific vehicle make and model.

19. The method of claim 16, further comprising:
using the DSI apparatus to receive a Portable Document Format (PDF) document representing a completed contract and to forward the PDF document to the second selected one of the dealer computer systems.

20. The method of claim 16, further comprising using the DSI apparatus to assist the provider network with electronic contract booking of a contract transmitted between one of the first and second selected dealer computer systems and one of the provider computer systems.
